(19) United States
(12) Patent Application Publication
(10) Pub. No.: US 2020/0376655 A1
(43) Pub. Date: Dec. 3, 2020

(54) ACTION ROBOT, AUTHENTICATION METHOD THEREFOR, AND SERVER CONNECTED THERETO

(71) Applicant: LG ELECTRONICS INC., Seoul (KR)

(72) Inventors: Yongkyoung SHIN, Seoul (KR); Sanghun KIM, Seoul (KR)

(73) Assignee: LG ELECTRONICS INC., Seoul (KR)

(21) Appl. No.: 16/799,737

(22) Filed: Feb. 24, 2020

(30) Foreign Application Priority Data
May 30, 2019 (KR) 10-2019-0063740

(51) Int. Cl. B25J 9/16; B25J 9/00; B25J 11/00; B25J 9/08

(52) U.S. Cl. CPC B25J 9/161; B25J 9/0009; B25J 9/08; B25J 11/003; B25J 9/1653

(57) ABSTRACT

Disclosed herein is an action robot including a figure including an authentication memory in which identification information is stored and a base configured to output an action using the figure when the figure is mounted. The base includes a figure driver configured to drive the figure such that the figure outputs a predetermined action, a communication transceiver configured to establish connection with a management server for performing authentication of the mounted figure, a figure authenticator configured to acquire the identification information stored in the authentication memory when the figure is mounted, and a processor configured to control the communication transceiver to transmit the acquired identification information to the management server.

### CROSS-REFERENCE TO RELATED APPLICATIONS

Pursuant to 35 U.S.C. § 119(a), this application claims the benefit of earlier filing date and right of priority to Korean Patent Application No. 10-2019-0063740, filed on May 30, 2019, the contents of which are all hereby incorporated by reference herein in their entirety.

### BACKGROUND

The present disclosure relates to an action robot and, more particularly, to an action robot for performing authentication of a figure mounted on a base of the action robot, an authentication method therefor, and a server connected thereto.

As robot technology has been developed, methods of constructing a robot by modularizing joints or wheels have been used. For example, a plurality of actuator modules configuring the robot is electrically and mechanically connected and assembled, thereby manufacturing various types of robots such as dogs, dinosaurs, humans, spiders, etc.

A robot which may be manufactured by assembling the plurality of actuator modules is generally referred to as a modular robot. Each actuator module configuring the modular robot has a motor provided therein, such that motion of the robot is executed according to rotation of the motor. Motion of the robot includes action of a robot such as movement and dance.

Recently, as entertainment robots come to the front, interest in robots for inducing human interest or entertainment has been increasing. For example, technology for dancing to music or making motions or facial expressions to stores (fairy tales) has been developed.

By presetting a plurality of motions suiting music or fairy tales and performing predetermined motion to music or a fairy tale played back by an external apparatus, the action robot performs motion.

### SUMMARY

An object of the present disclosure is to provide a method capable of preventing a figure from be illegally provided and used by a third party in an action robot implemented in the form of a module.

Another object of the present disclosure is to provide a method capable of preventing another person from using the figure as identification information of a figure is duplicated or the figure is lost or stolen.

According to an embodiment, an action robot including a figure includes an authentication memory in which identification information is stored and a base configured to output an action using the figure when the figure is mounted. The base includes a figure driver configured to drive the figure such that the figure outputs a predetermined action, a communication transceiver configured to establish connection with a management server for performing authentication of the mounted figure, a figure authenticator configured to acquire the identification information stored in the authentication memory when the figure is mounted, and a processor configured to control the communication transceiver to transmit the acquired identification information to the management server.

The processor may receive a control signal related to an authentication result of the figure from the management server through the communication transceiver, and determine whether an action is output using the figure based on the received control signal.

The processor may prevent driving of the figure based on the received control signal when authentication of the figure by the management server has failed.

The processor may control the figure driver to output an action using the figure when authentication of the figure by the management server has succeeded.

The action robot may further include an output interface configured to output content data, and the processor may control the figure driver based on action control data corresponding to the content data.

In some embodiments, the content data and the action control data may be received from a server or a terminal connected through the communication transceiver.

The action robot may further include a memory configured to store identification information of the base, and the processor may transmit identification information of the figure and identification information of the base to the management server.

The processor may recognize a type of the figure or authenticates compatibility of the figure, based on authentication data stored in a memory and the acquired identification information.

In some embodiments, the figure authenticator may include a near field communication (NFC) reader, and the authentication memory may include an NFC tag.

According to another embodiment, a management server may be connected to an action robot including a figure configured to output an action and a base configured to drive the figure. The management server may include a communication transceiver configured to receive first identification information of the figure from the action robot, and a processor configured to perform authentication of the figure based on the received first identification information and user information received from a terminal, and transmit a control signal for activating or deactivating driving of the figure to the action robot based on an result of performing authentication of the figure.

The processor may further receive second identification information of the base from the action robot, determine whether the received first identification information is present in a database, receive the user information from a terminal matching the second identification information when the first identification information is present in the database, and perform authentication of the figure depending on whether the received user information matches user information matching the first identification information.

The processor may transmit a control signal for activating driving of the figure to the action robot when the received user information matches the user information matching the first identification information, and transmit a control signal for deactivating driving of the figure to the action robot when the received user information does not match the user information matching the first identification information.

The processor may transmit authentication success notification to the terminal when the received user information matches the user information matching the first identification information, and transmit authentication failure notification to the terminal when the received user information does not match the user information matching the first identification information.

The processor may transmit a user information request to a terminal matching the second identification information when the first identification information is not present in the database, and store the user information received from the terminal and the first identification information in the database.

### BRIEF DESCRIPTION OF THE DRAWINGS

FIG. 1 illustrates an AI device including a robot according to an embodiment of the present disclosure.

FIG. 2 illustrates an AI server connected to a robot according to an embodiment of the present disclosure.

FIG. 3 illustrates an AI system according to an embodiment of the present disclosure.

FIG. 4 is a perspective view of an action robot according to an embodiment of the present disclosure.

FIG. 5 is a view showing the configuration of an action robot system including the action robot shown in FIG. 4.

FIG. 6 is a block diagram showing the control configuration of an action robot according to an embodiment of the present disclosure.

FIG. 7 is a ladder diagram showing an example of operation of registering a figure of an action robot in a database in an action robot system according to an embodiment of the present disclosure.

FIG. 8 is a view showing an example related to operation of the action robot system shown in FIG. 7.

FIG. 9 is a view showing an example of a screen displayed on a terminal of a user when the figure is registered in the database according to the embodiment shown in FIG. 7.

FIG. 10 is a ladder diagram showing an example of authentication operation performed when a figure is mounted, in an action robot system according to an embodiment of the present disclosure.

### DETAILED DESCRIPTION OF THE EMBODIMENTS

Description will now be given in detail according to exemplary embodiments disclosed herein, with reference to the accompanying drawings. The accompanying drawings are used to help easily understand the embodiments disclosed in this specification and it should be understood that the embodiments presented herein are not limited by the accompanying drawings. As such, the present disclosure should be construed to extend to any alterations, equivalents and substitutes in addition to those which are particularly set out in the accompanying drawings.

Artificial intelligence refers to the field of studying artificial intelligence or methodology for making artificial intelligence, and machine learning refers to the field of defining various issues dealt with in the field of artificial intelligence and studying methodology for solving the various issues. Machine learning is defined as an algorithm that enhances the performance of a certain task through a steady experience with the certain task.

An artificial neural network (ANN) is a model used in machine learning and may mean a whole model of problem-solving ability which is composed of artificial neurons (nodes) that form a network by synaptic connections. The artificial neural network can be defined by a connection pattern between neurons in different layers, a learning process for updating model parameters, and an activation function for generating an output value.

The artificial neural network may include an input layer, an output layer, and optionally one or more hidden layers. Each layer includes one or more neurons, and the artificial neural network may include a synapse that links neurons to neurons. In the artificial neural network, each neuron may output the function value of the activation function for input signals, weights, and deflections input through the synapse.

Model parameters refer to parameters determined through learning and include a weight value of synaptic connection and deflection of neurons. A hyperparameter means a parameter to be set in the machine learning algorithm before learning, and includes a learning rate, a repetition number, a mini batch size, and an initialization function.

The purpose of the learning of the artificial neural network may be to determine the model parameters that minimize a loss function. The loss function may be used as an index to determine optimal model parameters in the learning process of the artificial neural network.

Machine learning may be classified into supervised learning, unsupervised learning, and reinforcement learning according to a learning method.

The supervised learning may refer to a method of learning an artificial neural network in a state in which a label for learning data is given, and the label may mean the correct answer (or result value) that the artificial neural network must infer when the learning data is input to the artificial neural network. The unsupervised learning may refer to a method of learning an artificial neural network in a state in which a label for learning data is not given. The reinforcement learning may refer to a learning method in which an agent defined in a certain environment learns to select a behavior or a behavior sequence that maximizes cumulative compensation in each state.

Machine learning, which is implemented as a deep neural network (DNN) including a plurality of hidden layers among artificial neural networks, is also referred to as deep learning, and the deep learning is part of machine learning. In the following, machine learning is used to mean deep learning.

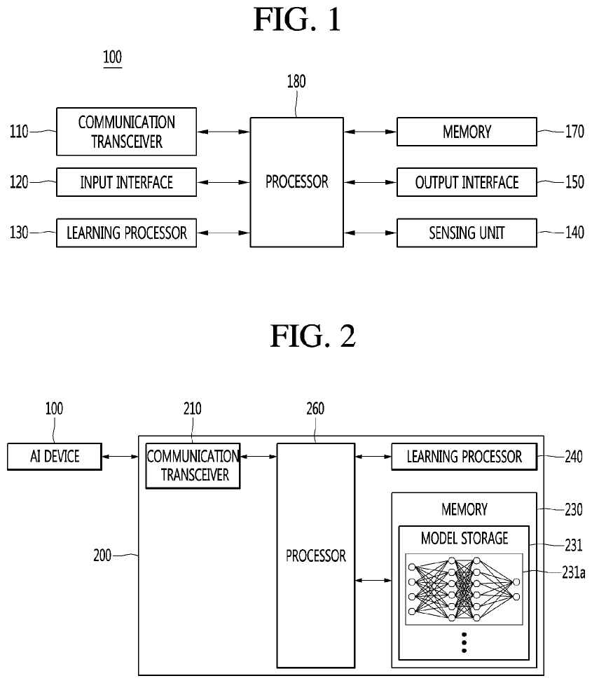

FIG. 1 illustrates an AI device including a robot according to an embodiment of the present disclosure.

The AI device 100 may be implemented by a stationary device or a mobile device, such as a TV, a projector, a mobile phone, a smartphone, a desktop computer, a notebook, a digital broadcasting terminal, a personal digital assistant (PDA), a portable multimedia player (PMP), a navigation device, a tablet PC, a wearable device, a set-top box (STB), a DMB receiver, a radio, a washing machine, a refrigerator, a desktop computer, a digital signage, a robot, a vehicle, and the like.

Referring to FIG. 1, the AI device 100 may include a communication transceiver 110, an input interface 120, a learning processor 130, a sensing unit 140, an output interface 150, a memory 170, and a processor 180.

The communication transceiver 110 may transmit and receive data to and from external devices such as other AI devices 100a to 100e and the AI server 200 by using wire/wireless communication technology. For example, the communication transceiver 110 may transmit and receive sensor information, a user input, a learning model, and a control signal to and from external devices.

The communication technology used by the communication transceiver 110 includes GSM (Global System for Mobile communication), CDMA (Code Division Multi Access), LTE (Long Term Evolution), 5G, WLAN (Wireless LAN), Wi-Fi (Wireless-Fidelity), Bluetooth™, RFID (Radio Frequency Identification), Infrared Data Association (IrDA), ZigBee, NFC (Near Field Communication), and the like.

The input interface 120 may acquire various kinds of data.

At this time, the input interface 120 may include a camera for inputting a video signal, a microphone for receiving an audio signal, and a user input interface for receiving information from a user. The camera or the microphone may be treated as a sensor, and the signal acquired from the camera or the microphone may be referred to as sensing data or sensor information.

The input interface 120 may acquire a learning data for model learning and an input data to be used when an output is acquired by using learning model. The input interface 120 may acquire raw input data. In this case, the processor 180 or the learning processor 130 may extract an input feature by preprocessing the input data.

The learning processor 130 may learn a model composed of an artificial neural network by using learning data. The learned artificial neural network may be referred to as a learning model. The learning model may be used to an infer result value for new input data rather than learning data, and the inferred value may be used as a basis for determination to perform a certain operation.

At this time, the learning processor 130 may perform AI processing together with the learning processor 240 of the AI server 200.

At this time, the learning processor 130 may include a memory integrated or implemented in the AI device 100. Alternatively, the learning processor 130 may be implemented by using the memory 170, an external memory directly connected to the AI device 100, or a memory held in an external device.

The sensing unit 140 may acquire at least one of internal information about the AI device 100, ambient environment information about the AI device 100, and user information by using various sensors.

Examples of the sensors included in the sensing unit 140 may include a proximity sensor, an illuminance sensor, an acceleration sensor, a magnetic sensor, a gyro sensor, an inertial sensor, an RGB sensor, an IR sensor, a fingerprint recognition sensor, an ultrasonic sensor, an optical sensor, a microphone, a lidar, and a radar.

The output interface 150 may generate an output related to a visual sense, an auditory sense, or a haptic sense.

At this time, the output interface 150 may include a display for outputting time information, a speaker for outputting auditory information, and a haptic interface for outputting haptic information.

The memory 170 may store data that supports various functions of the AI device 100. For example, the memory 170 may store input data acquired by the input interface 120, learning data, a learning model, a learning history, and the like.

The processor 180 may determine at least one executable operation of the AI device 100 based on information determined or generated by using a data analysis algorithm or a machine learning algorithm. The processor 180 may control the components of the AI device 100 to execute the determined operation.

To this end, the processor 180 may request, search, receive, or utilize data of the learning processor 130 or the memory 170. The processor 180 may control the components of the AI device 100 to execute the predicted operation or the operation determined to be desirable among the at least one executable operation.

When the connection of an external device is required to perform the determined operation, the processor 180 may generate a control signal for controlling the external device and may transmit the generated control signal to the external device.

The processor 180 may acquire intention information for the user input and may determine the user's requirements based on the acquired intention information.

The processor 180 may acquire the intention information corresponding to the user input by using at least one of a speech to text (STT) engine for converting speech input into a text string or a natural language processing (NLP) engine for acquiring intention information of a natural language.

At least one of the STT engine or the NLP engine may be configured as an artificial neural network, at least part of which is learned according to the machine learning algorithm. At least one of the STT engine or the NLP engine may be learned by the learning processor 130, may be learned by the learning processor 240 of the AI server 200, or may be learned by their distributed processing.

The processor 180 may collect history information including the operation contents of the AI apparatus 100 or the user's feedback on the operation and may store the collected history information in the memory 170 or the learning processor 130 or transmit the collected history information to the external device such as the AI server 200. The collected history information may be used to update the learning model.

The processor 180 may control at least part of the components of AI device 100 so as to drive an application program stored in memory 170. Furthermore, the processor 180 may operate two or more of the components included in the AI device 100 in combination so as to drive the application program.

FIG. 2 illustrates an AI server connected to a robot according to an embodiment of the present disclosure.

Referring to FIG. 2, the AI server 200 may refer to a device that learns an artificial neural network by using a machine learning algorithm or uses a learned artificial neural network. The AI server 200 may include a plurality of servers to perform distributed processing, or may be defined as a 5G network. At this time, the AI server 200 may be included as a partial configuration of the AI device 100, and may perform at least part of the AI processing together.

The AI server 200 may include a communication transceiver 210, a memory 230, a learning processor 240, a processor 260, and the like.

The communication transceiver 210 can transmit and receive data to and from an external device such as the AI device 100.

The memory 230 may include a model storage 231. The model storage 231 may store a learning or learned model (or an artificial neural network 231a) through the learning processor 240.

The learning processor 240 may learn the artificial neural network 231a by using the learning data. The learning model may be used in a state of being mounted on the AI server 200 of the artificial neural network, or may be used in a state of being mounted on an external device such as the AI device 100.

The learning model may be implemented in hardware, software, or a combination of hardware and software. If all or part of the learning models are implemented in software, one or more instructions that constitute the learning model may be stored in memory 230.

The processor 260 may infer the result value for new input data by using the learning model and may generate a response or a control command based on the inferred result value.

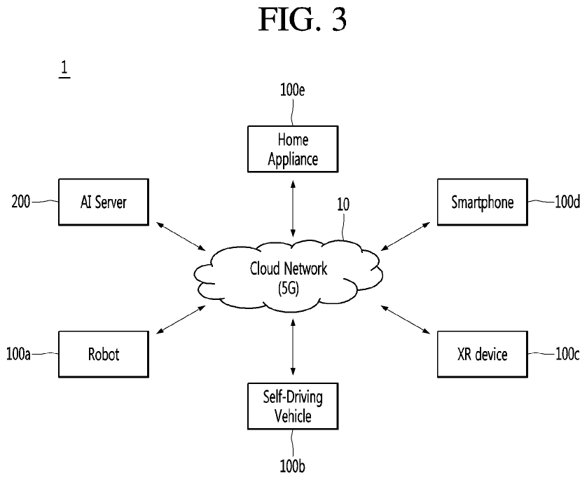

FIG. 3 illustrates an AI system including a robot according to an embodiment of the present disclosure.

Referring to FIG. 3, in the AI system 1, at least one of an AI server 200, a robot 100a, a self-driving vehicle 100b, an XR device 100c, a smartphone 100d, or a home appliance 100e is connected to a cloud network 10. The robot 100a, the self-driving vehicle 100b, the XR device 100c, the smartphone 100d, or the home appliance 100e, to which the AI technology is applied, may be referred to as AI devices 100a to 100e.

The cloud network 10 may refer to a network that forms part of a cloud computing infrastructure or exists in a cloud computing infrastructure. The cloud network 10 may be configured by using a 3G network, a 4G or LTE network, or a 5G network.

That is, the devices 100a to 100e and 200 configuring the AI system 1 may be connected to each other through the cloud network 10. In particular, each of the devices 100a to 100e and 200 may communicate with each other through a base station, but may directly communicate with each other without using a base station.

The AI server 200 may include a server that performs AI processing and a server that performs operations on big data.

The AI server 200 may be connected to at least one of the AI devices constituting the AI system 1, that is, the robot 100a, the self-driving vehicle 100b, the XR device 100c, the smartphone 100d, or the home appliance 100e through the cloud network 10, and may assist at least part of AI processing of the connected AI devices 100a to 100e.

At this time, the AI server 200 may learn the artificial neural network according to the machine learning algorithm instead of the AI devices 100a to 100e, and may directly store the learning model or transmit the learning model to the AI devices 100a to 100e.

At this time, the AI server 200 may receive input data from the AI devices 100a to 100e, may infer the result value for the received input data by using the learning model, may generate a response or a control command based on the inferred result value, and may transmit the response or the control command to the AI devices 100a to 100e.

Alternatively, the AI devices 100a to 100e may infer the result value for the input data by directly using the learning model, and may generate the response or the control command based on the inference result.

Hereinafter, various embodiments of the AI devices 100a to 100e to which the above-described technology is applied will be described. The AI devices 100a to 100e illustrated in FIG. 3 may be regarded as a specific embodiment of the AI device 100 illustrated in FIG. 1.

The robot 100a, to which the AI technology is applied, may be implemented as a guide robot, a carrying robot, a cleaning robot, a wearable robot, an entertainment robot, a pet robot, an unmanned flying robot, or the like.

The robot 100a may include a robot control module for controlling the operation, and the robot control module may refer to a software module or a chip implementing the software module by hardware.

The robot 100a may acquire state information about the robot 100a by using sensor information acquired from various kinds of sensors, may detect (recognize) surrounding environment and objects, may generate map data, may determine the route and the travel plan, may determine the response to user interaction, or may determine the operation.

The robot 100a may use the sensor information acquired from at least one sensor among the lidar, the radar, and the camera so as to determine the travel route and the travel plan.

The robot 100a may perform the above-described operations by using the learning model composed of at least one artificial neural network. For example, the robot 100a may recognize the surrounding environment and the objects by using the learning model, and may determine the operation by using the recognized surrounding information or object information. The learning model may be learned directly from the robot 100a or may be learned from an external device such as the AI server 200.

At this time, the robot 100a may perform the operation by generating the result by directly using the learning model, but the sensor information may be transmitted to the external device such as the AI server 200 and the generated result may be received to perform the operation.

The robot 100a may use at least one of the map data, the object information detected from the sensor information, or the object information acquired from the external apparatus to determine the travel route and the travel plan, and may control the driving unit (e.g., driving motor) such that the robot 100a travels along the determined travel route and travel plan.

The map data may include object identification information about various objects arranged in the space in which the robot 100a moves. For example, the map data may include object identification information about fixed objects such as walls and doors and movable objects such as pollen and desks. The object identification information may include a name, a type, a distance, and a position.

In addition, the robot 100a may perform the operation or travel by controlling the driving unit based on the control/interaction of the user. At this time, the robot 100a may acquire the intention information of the interaction due to the user's operation or speech utterance, and may determine the response based on the acquired intention information, and may perform the operation.

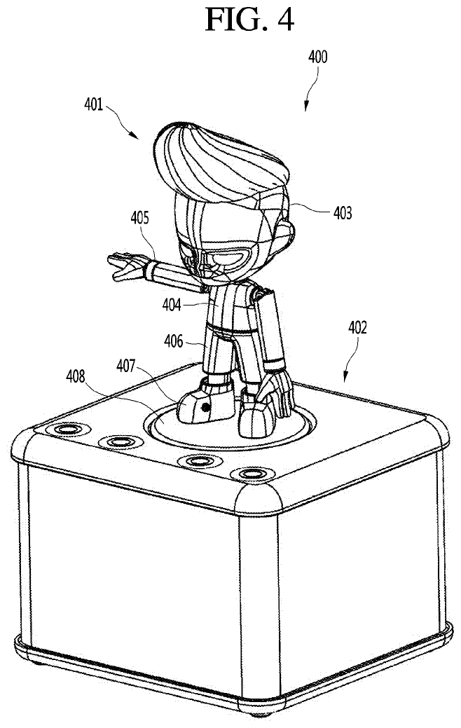

FIG. 4 is a perspective view of an action robot according to an embodiment of the present disclosure.

Referring to FIG. 4, the action robot 400 may include a figure 401 and a base 402 supporting the figure 401 from below.

The figure 401 may have a shape approximately similar to that of a human body.

The figure 401 may include a head 403, bodies 404 and 406, and arms 405. The figure 401 may further include feet 407 and a sub base 408.

The head 403 may have a shape corresponding to a human head. The head 403 may be connected to the upper portion of the body 404.

The bodies 404 and 406 may have a shape corresponding to a human body. The bodies 404 and 406 may be fixed and may not move. Spaces in which various parts may be received may be formed in the bodies 404 and 406.

The body may include a first body 404 and a second body 406.

The internal space of the first body 404 and the internal space of the second body 406 may communicate with each other.

The first body 404 may have a shape corresponding to a human upper body. The first body 404 may be referred to as an upper body. The first body 404 may be connected with the arms 405.

The second body 406 may have a shape corresponding to a human lower body. The second body 406 may be referred to as a lower body. The second body 406 may include a pair of legs.

The first body 404 and the second body 406 may be detachably fastened to each other. Therefore, it is possible to conveniently assemble the bodies and to easily repair parts disposed in the bodies.

The arms 405 may be connected to both sides of the body.

More specifically, the pair of arms 405 may be connected to the shoulders located at both sides of the first body 404. The shoulders may be included in the first body 404. The shoulders may be located at the upper portions of both sides of the first body 404.

The arms 405 may be rotated relative to the first body 404, and, more particularly, the shoulders. Accordingly, the arms 405 may be referred to as a movable part.

The pair of arms 405 may include a right arm and a left arm. The right arm and the left arm may independently move.

The feet 407 may be connected to the lower portion of the second body 406, that is, the lower ends of legs. The feet 407 may be supported by the sub base 408.

The sub base 408 may be fastened to at least one of the second body 406 or the feet 407. The sub base 408 may be seated in and coupled to the base 402 at the upper side of the base 402.

The sub base 408 may have a substantially disc shape. The sub base 408 may rotate relative to the base 402. Accordingly, the entire figure 401 may rotate relative to the sub base 408.

Meanwhile, an authentication memory containing identification information for authentication of the figure 401 may be provided inside the sub base 408. The authentication memory may be implemented by various types of electronic chips such as a near field communication (NFC) tag or an IC chip, a memory, etc. The identification information may be information indicating the type of the figure 401 or information for distinguishing the figure 401 from other figures and may include a variety of identification information such as a serial number.

The base 402 may support the figure 401 from below. More specifically, the base 402 may support the sub base 408 of the figure 401 from below. The sub base 408 may be detachably coupled to the base 402.

A processor 480 (see FIG. 6) for controlling overall operation of an action robot 1, a battery (not shown) for storing power necessary for operation of the action robot 1, and a figure driver 460 (see FIG. 6) for operating the figure 401 may be mounted on the base 402. In addition, a speaker 452 (see FIG. 6) for outputting sound may be disposed in the base 402. In some embodiments, a display 454 for outputting various types of information in a visual form may be disposed on one surface of the base 402.

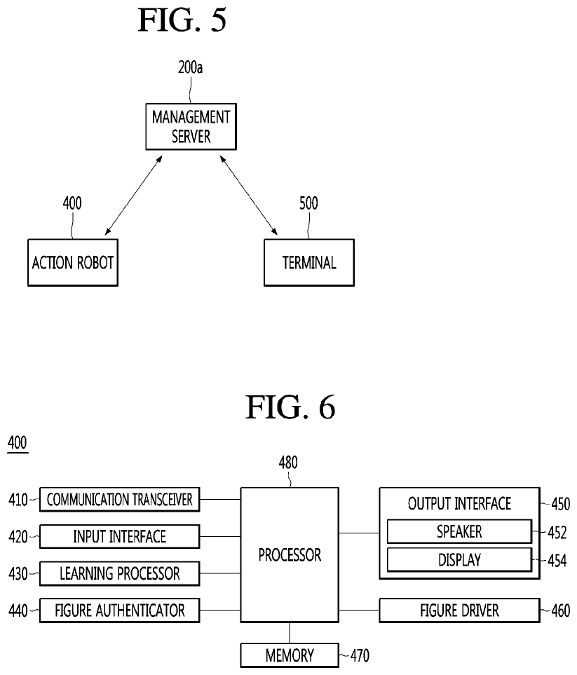

FIG. 5 is a view showing the configuration of an action robot system including the action robot shown in FIG. 4.

Referring to FIG. 5, the action robot system may include a management server 200a, an action robot 400 and a terminal 500.

The action robot 400 may provide a predetermined action (choreography, gesture, etc.) through the figure 401. In addition, the action robot 400 may drive the figure 401 to provide an action related to predetermined content while outputting the predetermined content (e.g., music, fairy tale, educational content, etc.) through an output interface 450 (see FIG. 6). Therefore, the action robot 400 may more efficiently provide the content to a user.

The management server 200a may provide various types of services through the action robot 400. For example, the management server 200a may provide the predetermined content to the action robot 400, and provide action control data for driving of the figure 401.

Meanwhile, the management server 200a may store information on the figure 401 and the base 402 included in the action robot 400 and user information in the database, thereby performing a registration procedure for allowing the user to use the service provided by the management server 200a.

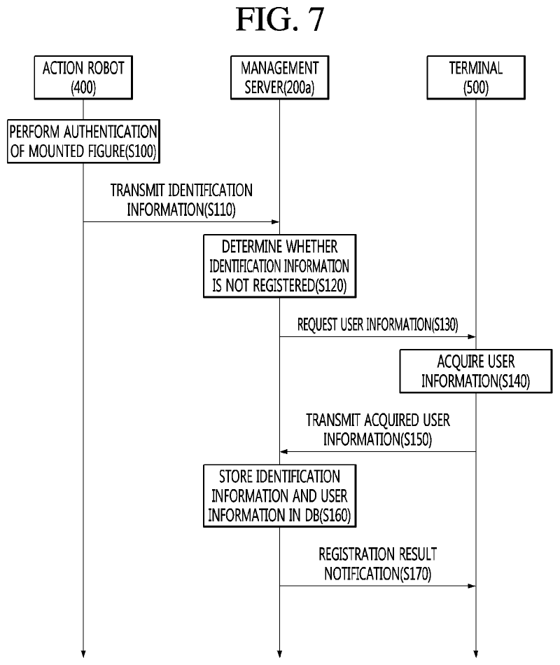

In particular, the management server 200a may perform an authentication procedure when the figure 401 and the base 402 are used based on the information stored in the database, thereby preventing the figure 401 from being used by a person other than a correct user. This will be described below with reference to FIGS. 7 to 10.

The management server 200a may be included in the AI server 200 described with reference to FIG. 2. That is, the description related to the AI server 200 described above with reference to FIGS. 2 to 3 is similarly applicable to the management server 200a.

Meanwhile, the user of the action robot 400 may control operation of the action robot 400 through the terminal 500 or register the action robot 400 in the database of the management server 200a.

For example, the terminal 500 may be connected to the management server 200a through an application related to the service, and control operation of the action robot 400 through the management server 200a.

The terminal 500 may mean a mobile terminal such as a smartphone, a tablet PC, etc. and, in some embodiments, may include a fixed terminal such as a desktop PC.

Meanwhile, although the action robot 400 and the terminal 500 are connected to each other through the management server 200a in this specification, the action robot 400 and the terminal 500 may be directly connected without the management server 200a.

FIG. 6 is a block diagram showing the control configuration of an action robot according to an embodiment of the present disclosure.

Referring to FIG. 6, the action robot 400 may include a communication transceiver 410, an input interface 420, a learning processor 430, a figure authenticator 440, an output interface 450, a figure driver 460, a memory 470 and a processor 480. The components shown in FIG. 6 are examples for convenience of description and the action robot 400 may include more or fewer components than those shown in FIG. 6.

The components shown in FIG. 6 may be provided in the base 402 of the action robot 400. That is, the base 402 may configure the body of the action robot 400, and the figure 401 may be detached from the base 402, such that the action robot 400 is implemented as a modular robot.

Meanwhile, the description related to the AI device 100 of FIGS. 1 to 2 is similarly applicable to the action robot 400 of the present disclosure. That is, the communication transceiver 410, the input interface 420, the learning processor 430, the output interface 450, the memory 470, and the processor 480 may correspond to the communication transceiver 110, the input interface 120, the learning processor 130, the output interface 150, the memory 170 and the processor 180 shown in FIG. 1, respectively.

The communication transceiver 410 may include communication modules for connecting the action robot 400 to the management server 200a or the terminal 500 over a network. The communication modules may support any one of the communication technologies described above with reference to FIG. 1.

For example, the action robot 400 may be connected to the network through an access point such as a router. Therefore, the action robot 400 may receive various types of information, data or content from the management server 200a or the terminal 500 over the network.

The input interface 420 may include at least one input part for acquiring input or commands related to operation of the action robot 400 or acquiring various types of data. For example, the at least one input part may include a physical input part such as a button or a dial, a touch input interface such as a touchpad or a touch panel, a microphone for receiving user's speech, etc.

Meanwhile, the processor 480 may transmit the speech data of a user received through the microphone to a server through the communication transceiver 410. The server may analyze the speech data to recognize a wakeup word, a command word, a request, etc. in the speech data, and provide a result of recognition to the action robot 400.

The server may be the management server 200a of FIG. 5 or a separate speech recognition server. In some embodiments, the server may be implemented as the AI server 200 described above with reference to FIG. 2. In this case, the server may recognize a wakeup word, a command word, a request, etc. in the speech data via a model (artificial intelligence network 231a) trained through the learning processor 240. The processor 480 may process the command word or request included in the speech based on the result of recognition.

In some embodiments, the processor 480 may directly recognize the wakeup word, the command word, the request, etc. in the speech data via a model trained by the learning processor 430 in the action robot 400. That is, the learning processor 430 may train a model composed of an artificial neural network using the speech data received through the microphone as training data.

Alternatively, the processor 480 may receive data corresponding to the trained model from server, store the data in the memory 470, and recognize the wakeup word, the command word, the request, etc. in the speech data through the stored data.

The learning processor 430 may train the model composed of the artificial neural network using the speech data of the user as described above. The model is applicable to recognize the wakeup word, the command word, the request, etc. from the speech data.

In some embodiments, the learning processor 430 may train the model composed of the artificial neural network using content data received from the management server 200a, a content provision server, the terminal 500, etc. The model is applicable to acquire data related to action control of the figure 401 corresponding to the characteristics of content data.

The figure authenticator 440 may perform authentication with respect to the figure 401 mounted on the base 402. Here, authentication may mean that the type of a currently mounted figure 401 is recognized when there is a plurality of types of figures mountable on the base 402.

For example, the figure authenticator 440 may include an NFC reader for reading an NFC tag provided in the figure 401. The NFC reader may acquire the identification information of the figure 401 contained in the NFC tag, as the figure 401 is mounted on the base 402. The identification information may include information related to the type of the figure 401 or include unique information (e.g., a serial number) of the figure 401.

For example, the identification information may include only a serial number. In this case, information on the type of the figure 401 corresponding to the serial number may be stored in the memory 470. Based on the stored information, the processor 480 may recognize the type of the figure 401 from the serial number acquired through the figure authenticator 440.

The output interface 450 may output various types of information related to operation or state of the action robot 400 or various services, programs, applications, etc. executed in the action robot 400 or various types of content (e.g., music, fairy tale, educational content, etc.). For example, the output interface 450 may include a speaker 452 and a display 454.

The speaker 452 may output the various types of information or messages or content in the form of speech or sound.

The display 454 may output the various types of information or messages in a graphic form. In some embodiments, the display 454 may be implemented in the form of a touchscreen along with a touch input interface. In this case, the display 454 may perform not only an output function but also an input function.

The figure driver 460 may operate the figure 401 mounted on the base 402 to provide an action through the figure 401.

For example, the figure driver 460 may include a servo motor or a plurality of motors. In another example, the figure driver 460 may include an actuator.

The processor 480 may receive action control data for control of the figure driver 460 through the management server 200a or the terminal 500. The processor 480 may control the figure driver 460 based on the received action control data, thereby providing the action of the figure 401 corresponding to the action control data.

Various types of data such as control data for controlling operation of the components included in the action robot 400, data for performing operation based on the command or request acquired through the communication transceiver 410 or input acquired through the input interface 420, etc. may be stored in the memory 470.

In addition, program data of software modules or applications executed by at least one processor or controller included in the processor 480 may be stored in the memory 470.

In addition, unique identification information of the action robot 400 (particularly, the base 402) may be stored in the memory 470. For example, the identification information may include an MAC address or a serial number of the base 402.

In addition, authentication data for authentication of the figure 401 mounted on the base 402 may be stored in the memory 470 according to the embodiment of the present disclosure. The authentication data may include a list of identification information (e.g., a serial number) stored in an authentication memory of the figure 401 or information or algorithms for recognizing the type of the figure 401 from the identification information.

The memory 470 may include various storage devices such as a ROM, a RAM, an EEPROM, a flash drive, a hard drive, etc. in hardware.

The processor 480 may control overall operation of the action robot 400. For example, the processor 480 may include at least one CPU, application processor (AP), microcomputer, integrated circuit, application specific integrated circuit (ASIC), etc.

The processor 480 may control the output interface 450 to output content data received from the management server 200a, the terminal 500, or the content provision server.

In addition, the processor 480 may control the figure driver 460 such that the figure 401 performs a predetermined action while the content data is output or regardless of output of the content data.

In addition, when the figure 401 is mounted on the base 402, the processor 480 may control the figure authenticator 440 to perform authentication and recognition of the figure 401.

The action robot 400 may be implemented such that the figure 401 is capable of being attached to or detached from the base 402, as described above. Therefore, the action robot 400 may provide various actions through various characters, by interchangeably mounting various types of figures 401 on the base 402.

Meanwhile, the manufacturer of the action robot may provide the above-described figure authenticator 440 in the base 402 and provide an authentication memory in the figure, in order to prevent a figure illegally manufactured by an unauthorized third party from being mounted and used in the base 402.

However, since the identification information included in the authentication memory may be easily duplicated by the third party, it is impossible to prevent the figure manufactured by the third party from being used only using the figure authenticator 440.

In addition, when the figure of the user has been lost or stolen, it is necessary to prevent another person from using the figure without authentication.

Embodiments of the action robot system for solving the above-described problems will be described with reference to FIGS. 7 to 10.

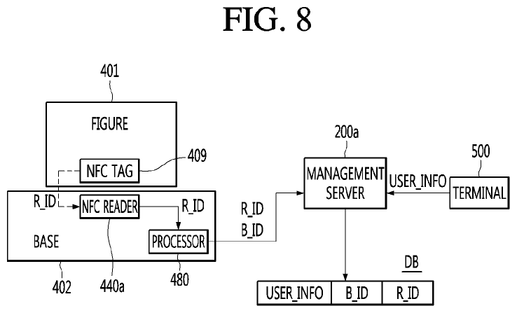

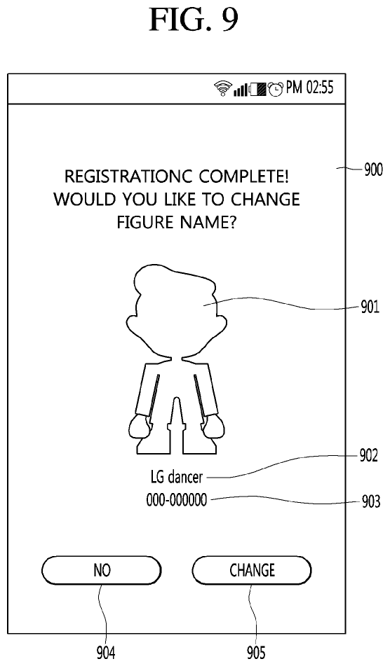

FIG. 7 is a ladder diagram showing an example of operation of registering a figure of an action robot in a database in an action robot system according to an embodiment of the present disclosure. FIG. 8 is a view showing an example related to operation of the action robot system shown in FIG. 7. FIG. 9 is a view showing an example of a screen displayed on a terminal of a user when the figure according to the embodiment shown in FIG. 7 is registered in the database.

Referring to FIGS. 7 and 8, the action robot 400 may perform authentication with respect to the mounted figure 401 when the figure 401 is mounted on the base 402 (S100).

When the figure 401 is mounted on the base 402, the processor 480 may acquire the identification information of the figure 401 from the authentication memory of the figure 401 through the figure authenticator 440. For example, the identification information may include the serial number of the figure 401.

For example, the figure authenticator 440 may include an NFC reader 440a, and the authentication memory of the figure 401 may include an NFC tag 409.

The NFC tag 409 may be provided in the sub base 408 of the figure 401. In addition, the NFC reader 440a may be disposed at a position adjacent to the sub base 408 in the internal space of the base 402.

As the figure 401 is mounted on the base 402, a distance between the NFC reader 440a and the NFC tag 409 may be within a predetermined distance. In this case, the NFC reader 440a may acquire the identification information R_ID of the figure 401 from the NFC tag 409, and the processor 480 may acquire the identification information R_ID from the NFC reader 440a.

The processor 480 may perform authentication of the figure 401 based on the acquired identification information R_ID. For example, the processor 480 may recognize the type of the figure 401 using authentication data stored in the memory 470.

In some embodiments, if the figure 401 of the type compatible with the base 402 is limited, the processor 480 may determine whether the recognized figure 401 is compatible with the base 402. The processor 480 may complete authentication when the figure 401 is compatible with the base 402 as a result of determination, and output a message corresponding to authentication failure (for example, indicating that the figure is incompatible) through the output interface 450 when the figure 401 is incompatible with the base 402.

In some embodiments, the acquired identification information R_ID may not be authenticated through the authentication data. For example, when the figure 401 is illegally produced by a third party, a serial number included in the identification information R_ID may not be included in a serial number list included in the authentication data. In this case, the processor 480 may output a message corresponding to authentication failure through the output interface 450 and prevent driving of the figure driver 460 without performing a subsequent registration procedure.

When authentication is normally performed, the action robot 400 may transmit the identification information of the action robot 400 to the management server 200a (S110).

When authentication of the figure 401 is completed, the processor 480 may transmit the identification information R_ID received from the figure 401 and the identification information B_ID of the base 402 stored in the memory 470 to the management server 200a.

For example, the identification information B_ID of the base 402 may include unique information such as the MAC address or the serial number of the base 402.

The management server 200a may determine whether the identification information R_ID and B_ID received from the action robot 400 is registered in a database DB. When the identification information is not present in the database DB, the management server 200a may determine that the identification information is not registered (S120).

The identification information of the base and the identification information of the figure may be stored in the database DB as registration information for use of a service provided through the action robot. In addition, user information of the figure and the base may also be stored in the database DB. That is, the identification information of the figure and the identification information of the base may be managed for each user of the service provided through the action robot. In some embodiments, when a user has a plurality of bases, there may be a plurality of pieces of identification information of the bases corresponding to the user information. Similarly, when a user has a plurality of figures, there may be a plurality of pieces of identification information of the figures corresponding to the user information.

The database DB may be included in the management server 200a or a server connected to the management server 200a.

Meanwhile, the user information USER_INFO and the identification information B_ID of the base 402 may be registered in the database DB in advance. In addition, when a user purchases and mounts a new figure 401 on the base 402, the identification information R_ID of the figure 401 may not be registered in the database DB in advance.

That is, the processor 260 of the management server 200a may perform operation of registering the identification information R_ID in the database DB, upon determining that the identification information R_ID of the figure 401 of the identification information of the action robot 400 is not registered in the database DB.

In some embodiments, upon determining that both the identification information R_ID of the figure and the identification information B_ID of the base are not registered in the database DB, the processor 260 may perform operation of registering the identification information R_ID of the figure and the identification information B_ID of the base in the database DB.

The management server 200a may request user information from the terminal 500 of the user in order to match the user of the action robot 400 with the action robot 400 to perform management (S130).

The processor 260 may control the communication transceiver 210 to transmit the request for transmitting the user information to the terminal 500, in order to match the identification information of the action robot 400 and, more particularly, the identification information R_ID of the figure 401, with the user information USER_INFO to perform registration.

The user information USER_INFO may include an identification (ID), the MAC address and the phone number of the terminal 500, etc. as information for identification of the user.

For example, the user information USER_INFO corresponding to the identification information B_ID of the base 402 may be stored in the database DB in advance. Since the identification information B_ID of the base 402 is transmitted from the action robot 400 to the management server 200a in step S110, the processor 260 may transmit the request for transmitting the user information to the terminal 500 of the user among the plurality of terminals based on the user information USER_INFO corresponding to the received identification information B_ID.

In some embodiments, the processor 260 may request further transmission of figure management information of the figure 401 to be registered, in addition to the user information USER_INFO. For example, the figure management information may include nickname information set with respect to the figure 401, for easy identification or management of the figure 401 by the user.

The terminal 500, which has received request for user information, may acquire user information from the user (S140), and transmit the acquired user information to the management server 200a (S150).

The terminal 500 may receive the user information USER_INFO from the user, and transmit the received user information USER_INFO to the management server 200a, using an application related to a service provided through the action robot.

In some embodiments, the terminal 500 may transmit the user information USER_INFO and the figure management information to the management server 200a.

The management server 200a may store the identification information and the user information in the database DB (S160).

The processor 260 may store the identification information R_ID and B_ID received from the action robot 400 and the user information USER_INFO received from the terminal 500 in the database DB.

The processor 260 may manage the identification information R_ID and B_ID for each user who uses the service, by matching the identification information R_ID and B_ID with the user information USER_INFO and storing the information in the database DB.

Meanwhile, the identification information B_ID of the base 402 and the user information USER_INFO may be stored in the database DB in advance. The processor 260 may store and manage the identification information R_ID of the figure 401 in the database DB along with the previously stored user information USER_INFO and the identification information B_ID of the base 402, when the user information USER_INFO received from the terminal 500 matches the user information USER_INFO stored in the database DB.

The identification information R_ID and B_ID and the user information USER_INFO may be stored in the database DB, thereby completing registration operation of the action robot 400, and, more particularly, the figure 401.

The management server 200a may notify the terminal 500 of the user of a registration result, as registration of the figure 401 is completed (S170).

The processor 260 may transmit, to the terminal 500, information or a message indicating that registration of the figure 401 has been completed.

Referring to FIG. 9, for example, the terminal 500 may display the registration screen 900 of the figure 401 through an application, when the information or the message is received.

For example, the registration screen 900 may include text indicating that registration of the figure 401 has been completed, the image 901 of the figure 401, the figure management information 902 (e.g., a nickname) registered in the management server 200a, and identification information 903 (e.g., a serial number).

In some embodiments, the registration screen 900 may further include buttons 904 and 905 for allowing the user to select whether to modify the figure management information 902. The user may select any one of the buttons 904 and 905 and may or may not change the figure management information 902.

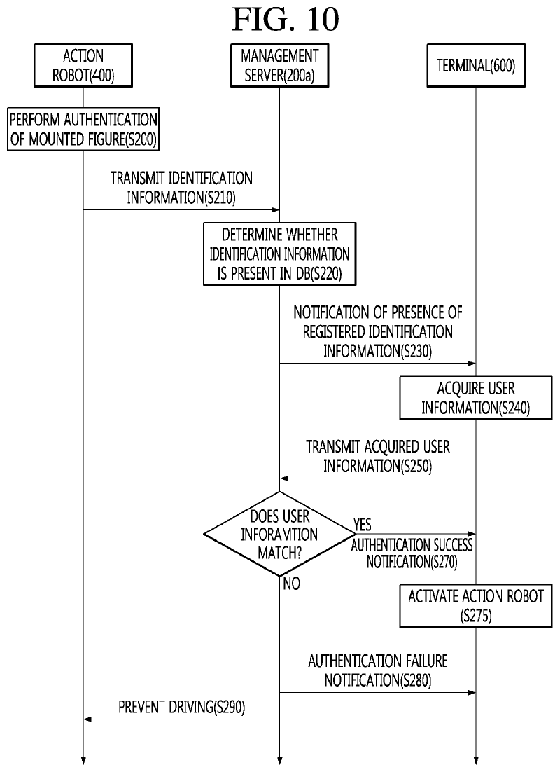

That is, according to the embodiments shown in FIGS. 7 to 9, the action robot system may match the identification information of the figure 401 with the user information and the identification information of the base and perform registration, when a new figure 401 is mounted on the base 402. Therefore, as described below with reference to FIG. 10, it is possible to efficiently prevent the figure having illegally duplicated identification information from being used. In addition, it is possible to prevent the registered figure from being mounted and used in the base of another person due to lost or stolen.

FIG. 10 is a ladder diagram showing an example of authentication operation performed when a figure is mounted, in an action robot system according to an embodiment of the present disclosure.

Referring to FIG. 10, the action robot 400 may perform authentication with respect to the mounted figure 401 when the figure 401 is mounted on the base 402 (S200). The action robot 400 may transmit the identification information of the action robot 400 to the management server 200a when authentication is normally performed (S210).

Steps S200 and S210 are substantially equal to steps S100 and S110 of FIG. 7 and thus a description thereof will be omitted.

The management server 200a may determine whether the identification information received from the action robot 400 is present in the database (S220).

The processor 260 may determine whether the received identification information R_ID and B_ID is registered in the database DB. For example, although the processor 260 may determine whether the identification information R_ID of the figure 401 is registered in the database DB, whether each of the received identification information R_ID and B_ID is registered in the database may be determined in some embodiments.

Upon determining that the identification information is present in the database, the management server 200a may notify the terminal 600 that the registered identification information is present (S230).

When the identification information R_ID of the figure 401 is registered in the database DB, the management server 200a may determine (authenticate) whether the figure 401 is mounted by the user who has registered the identification information R_ID of the figure 401.

To this end, the processor 260 may transmit information indicating that the identification information R_ID of the figure 401 has been registered to the terminal 600 corresponding to the user information USER_INFO matching the identification information B_ID of the base 402.

In some embodiments, the processor 260 may perform the following steps S230 to S290 when the user information USER_INFO matching the identification information R_ID of the figure 401 received from the action robot 400 is different from the user information USER_INFO matching the identification information B_ID of the base 402.

In contrast, the processor 260 may not perform steps S230 to S260 of FIG. 10, when the user information USER_INFO corresponding to the identification information R_ID of the figure 401 received from the action robot 400 is equal to the user information USER_INFO corresponding to the identification information B_ID of the base 402. In this case, the processor 260 may notify the terminal 600 of authentication success and the terminal 600 may activate control of the action robot 400.

The terminal 600 may acquire the user information from the user (S240), and transmit the acquired user information to the management server 200a (S250).

The terminal 600 may acquire the user information USER_INFO from the user and transmit the acquired user information USER_INFO to the management server 200a, when the information indicating that the identification information R_ID of the figure 401 is registered is received from the management server 200a. In some embodiments, the terminal 600 may acquire the user information USER_INFO and the figure management information, and transmit the acquired user information USER_INFO and figure management information to the management server 200a.

The management server 200a may determine whether the user information received from the terminal 600 matches the user information matching the identification information stored in the database (S260).

The processor 260 may determine whether the figure 401 is mounted on the base 402 of the registered user, depending on whether the user information (and the figure management information) received from the terminal 600 matches the user information (and the figure management information) stored in the database DB.

Upon determining that the information matches (YES of S260), the management server 200a may notify the terminal 600 that authentication of the figure 401 has succeeded (S270). Therefore, control of the action robot 400 may be activated through the application executed in the terminal 600 (S275).

When the user information matching the identification information R_ID stored in the database DB matches the user information received from the terminal 600, the processor 260 may recognize that the figure 401 is mounted on the base 402 by the registered user (or by permission of the registered user). That is, in this case, the processor 260 may recognize that the result of performing authentication corresponds to authentication success.

Accordingly, the processor 260 may transmit authentication success notification to the terminal 600 to control the action robot 400 through the terminal 600. The application of the terminal 600, which has received authentication success notification, may activate control of the action robot 400. As control of the action robot 400 is activated, the user may use, through the terminal 600, a content output function of the action robot 400 and an action output function through the figure 401.

In some embodiments, the processor 260 may transmit a control signal for activating driving of the figure 401 to the action robot 400 when authentication has succeeded. The processor 480 of the action robot 400 may activate the figure driver 460 based on the received authentication success notification, thereby providing the action output function through the figure 401.

In contrast, upon determining that the information does not match (NO of S260), the management server 200a may notify the terminal 600 that authentication of the figure 401 has failed (S280). In addition, the management server 200a may transmit the control signal to the action robot 400 to prevent driving of the action robot 400 (S290).

When the user information matching the identification information R_ID stored in the database DB does not match the user information received from the terminal 600, the processor 260 may recognize that the figure 401 is mounted on the base 402 by a person other than the registered user. For example, this may correspond to the case where another person having a figure 401 having illegally duplicated identification information R_ID mounts the figure 401 on the base 402 or the case where another person mounts the figure 401 on the base 402 without permission of the registered user.

That is, in this case, the processor 260 may recognize that the result of performing authentication corresponds to authentication failure.

The processor 260 may transmit the authentication failure notification of the figure 401 to the terminal 600 when the user information does not match. In addition, the processor 260 may transmit a control signal for deactivating (preventing) driving of the action robot 400 to the action robot 400. The processor 480 of the action robot 400 may deactivate the figure driver 460 in response to the received control signal, thereby preventing action output of the figure 401. Alternatively, the processor 480 may prevent other functions (e.g., a content output function) provided not only through the figure driver 460 but also through the output interface 450.

That is, the processor 480 may determine whether the action output function using the figure 401 is provided, based on the figure authentication result of the management server 200a.

According to the embodiment shown in FIG. 10, the action robot system may authenticate whether the figure 401 is mounted by the registered user when the figure 401 is mounted on the base 402, thereby efficiently preventing the identification information R_ID from being illegally duplicated or the figure 401 from being lost/stolen and illegally used by another person.

Although not shown, the user of the figure 401 may delete the identification information R_ID of the figure 401 stored in the database DB, for transfer of the figure 401. For example, after step S275 of FIG. 10, the user may input a reset request of the figure 401 through the application of the terminal 600. The terminal 600 may transmit the received reset request to the management server 200a. The processor 260 of the management server 200a may delete the identification information R_ID of the figure 401 stored in the database DB in response to the received reset request. Thereafter, a new user of the figure 401 may register the identification information R_ID of the figure 401 in the database DB to match with the user information of the new user as described above with reference to FIGS. 7 to 9.

According to the embodiments of the present disclosure, a management server can authenticate whether a figure is mounted by a registered user when the figure of an action robot is mounted on a base, thereby effectively preventing identification information from being illegally duplicated or the figure from being lost/stolen and illegally used by another person.

In addition, when a new figure is mounted on the base of the action robot, the management server can match the identification information of the figure with the identification information of the base and register the identification information in a database. Therefore, the management server can efficiently manage the figure, the base and the user.

The foregoing description is merely illustrative of the technical idea of the present disclosure, and various changes and modifications may be made by those skilled in the art without departing from the essential characteristics of the present disclosure.

Therefore, the embodiments disclosed in the present disclosure are to be construed as illustrative and not restrictive, and the scope of the technical idea of the present disclosure is not limited by these embodiments.

The scope of the present disclosure should be construed according to the following claims, and all technical ideas within equivalency range of the appended claims should be construed as being included in the scope of the present disclosure.

What is claimed is:

1. An action robot comprising:
a figure including an authentication memory in which identification information is stored; and
a base configured to output an action using the figure when the figure is mounted,
wherein the base includes:
a figure driver configured to drive the figure such that the figure outputs a predetermined action;
a communication transceiver configured to establish connection with a management server for performing authentication of the mounted figure;
a figure authenticator configured to acquire the identification information stored in the authentication memory when the figure is mounted; and
a processor configured to control the communication transceiver to transmit the acquired identification information to the management server.

2. The action robot of claim 1, wherein the processor:
receives a control signal related to an authentication result of the figure from the management server through the communication transceiver, and
determines whether an action is output using the figure based on the received control signal.

3. The action robot of claim 2, wherein the processor prevents driving of the figure based on the received control signal when authentication of the figure by the management server has failed.

4. The action robot of claim 2, wherein the processor controls the figure driver to output an action using the figure when authentication of the figure by the management server has succeeded.

5. The action robot of claim 4, further comprising an output interface configured to output content data,
wherein the processor controls the figure driver based on action control data corresponding to the content data.

6. The action robot of claim 5, wherein the content data and the action control data are received from a server or a terminal connected through the communication transceiver.

7. The action robot of claim 1, further comprising a memory configured to store the identification information of the base,
wherein the processor transmits the identification information of the figure and the identification information of the base to the management server.

8. The action robot of claim 1, wherein the processor recognizes a type of the figure or authenticates compatibility of the figure, based on authentication data stored in a memory and the acquired identification information.

9. The action robot of claim 1,
wherein the figure authenticator includes a near field communication (NFC) reader, and
wherein the authentication memory includes an NFC tag.

10. A management server connected to an action robot including a figure configured to output an action and a base configured to drive the figure, the management server comprising:
a communication transceiver configured to receive first identification information of the figure from the action robot; and
a processor configured to:
perform authentication of the figure based on the received first identification information and user information received from a terminal, and
transmit a control signal for activating or deactivating driving of the figure to the action robot based on an result of performing authentication of the figure.

11. The management server of claim 10, wherein the processor:
further receives second identification information of the base from the action robot,
determines whether the received first identification information is present in a database,
receives the user information from a terminal matching the second identification information when the first identification information is present in the database, and
performs authentication of the figure depending on whether the received user information matches user information matching the first identification information.

12. The management server of claim 11, wherein the processor:
transmits a control signal for activating driving of the figure to the action robot when the received user information matches the user information matching the first identification information, and
transmits a control signal for deactivating driving of the figure to the action robot when the received user information does not match the user information matching the first identification information.

13. The management server of claim 11, wherein the processor:
transmits authentication success notification to the terminal when the received user information matches the user information matching the first identification information, and
transmits authentication failure notification to the terminal when the received user information does not match the user information matching the first identification information.

14. The management server of claim 11, wherein the processor:
transmits a user information request to a terminal matching the second identification information when the first identification information is not present in the database, and
stores the user information received from the terminal and the first identification information in the database.

15. A method of authenticating an action robot including a figure configured to output an action and a base configured to drive the figure, the method comprising:
by a management server connected to the action robot, receiving first identification information of the figure and second identification information of the base from the action robot;
receiving user information from a terminal matching the second identification information when the first identification information is present in a database;
performing authentication of the figure depending on whether the received user information matches user information matching the first identification information; and
activating or deactivating driving of the figure mounted on the base based on a result of performing authentication of the figure.

16. The method of claim 15, wherein the performing of the authentication includes:
recognizing authentication success when the received user information matches user information matching the first identification information, and
recognizing authentication failure when the received user information does not match the user information matching the first identification information.

17. The method of claim 16, wherein the activating or deactivating of the driving of the figure includes:
transmitting a control signal for activating driving of the robot to the action robot at the time of authentication success, and
transmitting a control signal for deactivating driving of the robot to the action robot at the time of authentication failure.

18. The method of claim 15, further comprising:
receiving user information from a terminal matching the second identification information when the first identification information is not present in the database; and
storing the received user information and the first identification information in the database.
